(19) United States
(12) Patent Application Publication
(10) Pub. No.: US 2020/0216604 A1
(43) Pub. Date: Jul. 9, 2020

(54) POLYPENTENAMER-SILICA COMPOSITE

(71) Applicants: HASSAN SAID BAZZI, DOHA (QA); MOHAMMED AL-HASHIMI, DOHA (QA); ROBERT TUBA, BUDAPEST (HU)

(72) Inventors: HASSAN SAID BAZZI, DOHA (QA); MOHAMMED AL-HASHIMI, DOHA (QA); ROBERT TUBA, BUDAPEST (HU)

(73) Assignee: QATAR FOUNDATION FOR EDUCATION, SCIENCE AND COMMUNITY DEVELOPMENT, DOHA (QA)

(21) Appl. No.: 16/623,295

(22) PCT Filed: Jun. 15, 2018
(86) PCT No.: PCT/US2018/037710

§ 371 Date: Dec. 16, 2019

Related U.S. Application Data
(60) Provisional application No. 62/520,523, filed on Jun. 15, 2017.

(51) Int. Cl. C08G 61/08; B60C 1/00; C07F 7/02

(52) U.S. Cl. CPC C08G 61/08; B60C 1/0016; C07F 7/025; C08G 2261/77; C08G 2261/3321; C08G 2261/1422; C08G 2261/128; C08G 2261/418

(57) ABSTRACT

A polypentenamer-silica composite can include a surface-modified silica compound and a polypentenamer chain grafted onto the surface-modified silica compound. The polypentenamer has physical properties similar to natural rubber. The polypentenamer-silica composite is recyclable. As such, the polypentenamer-silica composite can be used for manufacturing recyclable tires.

### TECHNICAL FIELD

The disclosure of the present patent application relates to recyclable polypentenamers, and particularly to a polypentenamer-silica composite.

### BACKGROUND ART

Many vehicle tires are typically formed from materials which are not easily recyclable. Prior attempts at providing “green” tire tread alternatives have either been ineffective or too costly to be feasible.

Accordingly, alternative materials that are recyclable, economical, and environmentally benign, while still providing a high performance tire, are urgently needed.

### DISCLOSURE OF INVENTION

A polypentenamer-silica composite can include a surface-modified silica compound and a polypentenamer chain grafted onto the surface-modified silica compound. The polypentenamer-silica composite is recyclable. As such, the polypentenamer-silica composite can be used for manufacturing recyclable tires.

Unlike conventional tires, recyclable tires made from the polypentenamer-silica composite described herein do not need to undergo vulcanization. Further, synthesis of the polypentenamer-silica composite makes use of petrochemical by-product, cyclopentene. Accordingly, use of the polypentenamer-silica composite can provide environmental advantages.

These and other features of the present disclosure will become readily apparent upon further review of the following specification and drawings.

### BRIEF DESCRIPTION OF DRAWINGS

FIG. 1 is a reaction scheme for preparing silica compound 3.

FIG. 2 is a reaction scheme for surface modifying compound 3, to produce the silica-grafted cyclic olefin 6 with the silica surface modified.

FIG. 3 is an NMR spectra of the surface-modified silica compound 6 after accumulation time of about 20 hours.

FIG. 4 is an NMR spectra of the surface-modified silica compound 6 after accumulation time of about 72 hours.

FIG. 5 is a comparative schematic representation of the composite prepared with linking compound and a composite prepared without linking compound.

FIG. 6 is a reaction scheme for preparing a composite without the linking compound.

FIG. 7 is a reaction scheme for preparing the composite with the linking compound (the polypentenamer-silica composite according to the present teachings).

FIG. 8 is a graph showing the G′, G″, and η* values as a function of the frequency, comparing the composite with surface-modified silica (12) to the composite without surface-modified silica (11).

FIG. 9 is a scheme of the reaction conducted to demonstrate catalytic decomposition of the composite (12).

FIG. 10 is an NMR spectra demonstrating the catalytic decomposition of the composite (12) with and without the addition of G2.

Similar reference characters denote corresponding features consistently throughout the attached drawings.

### BEST MODES FOR CARRYING OUT THE INVENTION

A polypentenamer-silica composite can include a surface-modified silica compound and a polypentenamer chain grafted onto the surface-modified silica compound. The polypentenamer can include trans-polypentenamer. In an embodiment, the polypentenamer is predominantly trans-polypentenamer Polypentenamer has physical properties similar to natural rubber. An exemplary polypentenamer-silica composite is provided below:

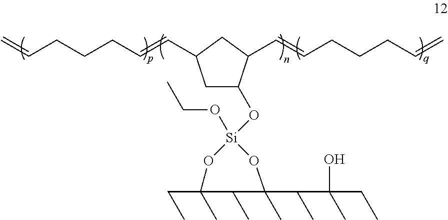

The polypentenamer-silica composite is recyclable. As such, the polypentenamer-silica composite can be useful for manufacturing recyclable tires.

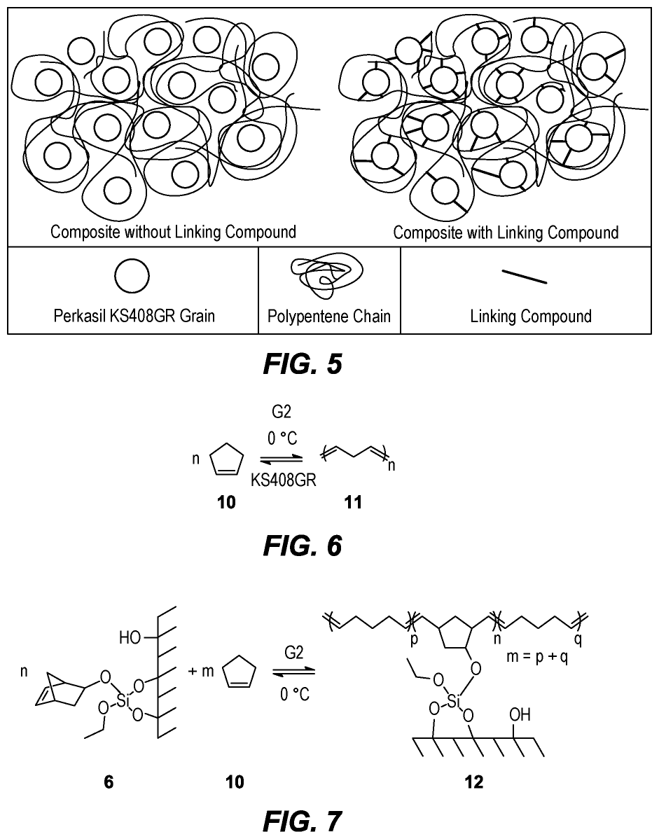

As described herein and illustrated in FIG. 5, two types of composites were prepared: one being the polypentenamer-silica composite with a linking compound (the surface-modified silica), and the other being a polypentenamer composite without the linking compound. The polypentenamer-silica composite according to the present teachings demonstrated increased viscosity compared to the polypentenamer composite without the linking compound.

A method for preparing the polypentenamer-silica composite can include performing ring opening metathesis polymerization (ROMP) of cyclopentene to provide a trans-polypentenamer and grafting the polypentenamer to a silica-grafted, strained cyclic olefin to provide the polypentenamer-silica composite. In an embodiment, the strained cyclic olefin is norbornene, and the silica surface is modified. In an embodiment, the silica-grafted, strained cyclic olefin is compound 6:

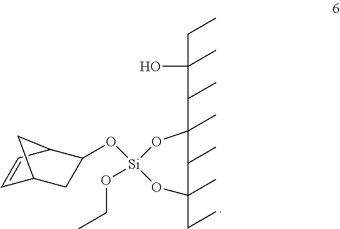 [SMILES: CCO[Si]1(OC2CC3C=CC2C3)OC(C)(CC)C(C)C(C)(C(C)C(C)(O)CC)O1]

Grafting the polypentenamer to compound 6 incorporates cyclopentanes into the polypentenamer chains to obtain the polypentenamer-silica composite. Cyclopentanes in the polypentenamer chain can serve as a cross-linking material between the silica and the polymer chains and between the polymer chains. In an exemplary embodiment, Grubbs' catalyst (G2) is used.

The trans-polypentenamer may be synthesized by equilibrium ROMP of cyclopentene, using known metathesis catalytic methods. ROMP is an equilibrium polymerization reaction resulting from the moderate ring strain energy of the cyclopentene used in the process. The equilibrium point can easily be shifted in either direction by properly changing the reaction conditions (reaction temperature and concentration) to shift the equilibrium in one direction or the other. This equilibrium polymerization is a unique technique for the development of durable and recyclable polymers.

The polypentenamers may be prepared and readily recycled using the same transition metal catalyst system. As the polypentenamers can be readily decomposed (via monomer recycling), other tire components, such as fillers, textiles and metal additives, also may be recycled. Accordingly, the composites described herein can be used to manufacture high-performance, recyclable tire additives.

The polypentenamers can be covalently bonded to the surface-modified silica compound to achieve optimal physical properties. For example, functionalizing polypentenamer with groups that have affinity for silica can improve the polymer's affinity for silica, resulting in better dispersed silica and, thereby, more fuel efficient tiers. Si(OR) can provide enhanced adhesion properties between the silicon filler and the elastomer. Accordingly, the composites can achieve better physical tire performance, compared to prior technologies.

The composites described herein can be used to produce high performance, recyclable tire additives, synthetic rubber, lubricants, and additives for other applications. The composites possess strong polymer and filler interaction. In addition to being recyclable, the composites described herein are produced from raw materials that are by-products of the petrochemical industry, e.g., cyclopentene, and are of limited commercial value otherwise. Thus, use and manufacture of the composites described herein can provide positive consequences for the environment.

By incorporating functional co-monomers into ROMP polymers, functional polypentenamer rubber containing as little as 1% co-monomer can be achieved. The polypentenamer rubber or polypentenamer-silica composite can provide a “green” or environmentally-friendly tire tread rubber with only marginally higher manufacturing costs than the base polypentenamer rubber. Such functional polypentenamer rubber can be effectively used as a major or minor rubber component in tire tread.

A method for making a recyclable tire can also include combining the polypentenamer with carbon black. Preferably, the carbon black is compatibilized prior to combining with the polypentenamer. For example, amine-substituted materials prepared from cyclopentadiene and aniline derivatives can be used to compatibilize carbon black. Phenol- and aniline-substituted polypentenamers can interact with the surface of the carbon black, producing a strong matrix interaction. Small samples may be prepared to determine the physical strength, using such standard techniques as thermal properties, and molecular weight characteristics, quantified by elemental analysis, mass spectroscopy, TGA/DSC, and high-temperature triple-detection GPC. Purity of the polymeric material can be assayed by microanalyses, and ICPMS. Kinetic investigations can be completed with in situ NMR spectroscopy.

The present teachings are illustrated by the following examples.

### EXAMPLES

### Example 1

### Synthesis of the Surface-Modified Silica

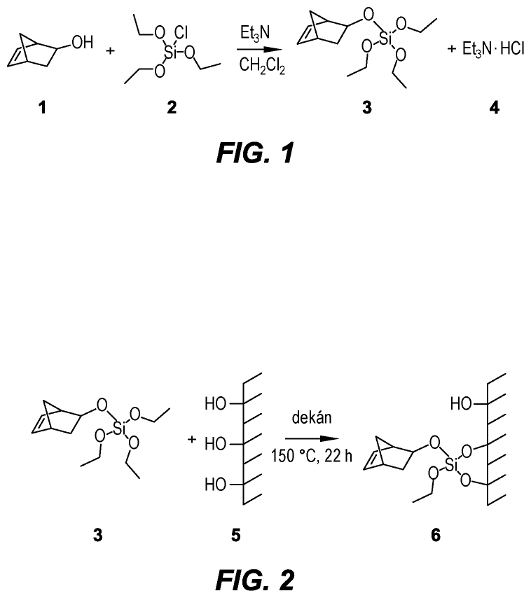

An exemplary reaction scheme for preparing Compound 3 is provided in FIG. 1. To a solution of compound 1 and dry TEA in 20 mL of dry dichloromethane, trimethylsilyl chloride was added dropwise over a duration of 5 min at a temperature of 0° C. White precipitation was observed. The stirring was continued at room temperature for 3 hours. After 3 hours, the mixture was pink. The mixture was washed with water (3×15 mL), and the residue was washed with NaCl (1×5 mL), and then dried with Na₂SO₄ and filtered. The product (compound 3) was dried under vacuum. Yield=96.0%.

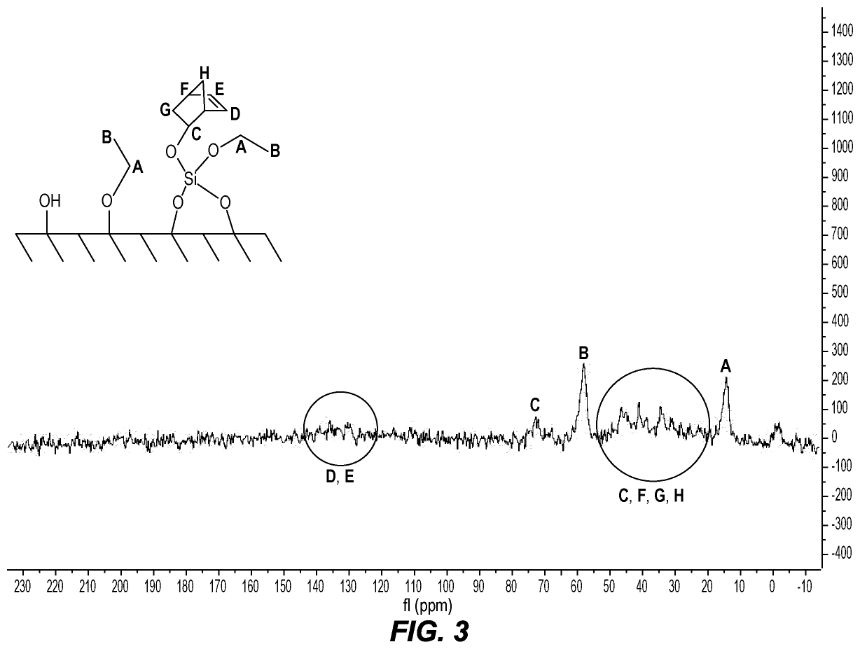

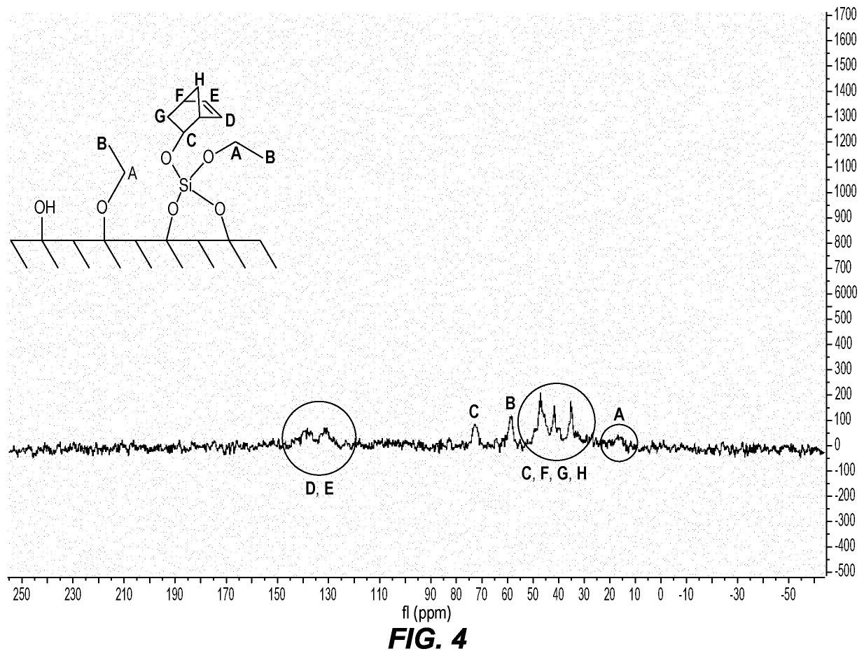

An exemplary reaction scheme for surface modification of Compound 3 to provide Compound 6 is provided in FIG. 2. With reference to FIG. 2, Perkasil® KS408GR was ground to a fine powder and dried under vacuum at 150° C. for 6 hours. The dried powder was then transferred to a round-bottom flask under Nitrogen, and placed in a glove box. In a small Schlenk flask, 0.25 g of compound 5, 8 mL of pentane, and 0.5 mL of compound 3 was added. The mixture was stirred at 70° C. for a period of 48 hours. After 48 hours of stirring, the mixture was filtered and washed (3×15 mL hexane, 3×15 mL DCM). The washed compound 6 was dried at 40° C. for 2 hours. NMR spectra were conducted after about 20 hours accumulation time (FIG. 3), and after about 72 hours accumulation time (FIG. 4).

### Example 2

### Synthesis of Polypentenamer-Silica Composite without Surface-Modified Silica

FIG. 6 depicts an exemplary reaction scheme for preparing a composite without the linking compound. Perkasil® KS408GR precipitated silica was ground to a fine powder and dried under vacuum at 150° C., for 6 hours. The dried powder was transferred to a round-bottom flask under Nitrogen, and the flask was transferred to a glove box. In a small Schlenk flask, 0.18 g silica and 2.0 mL of cyclopentene were added. Then, 1.0 mL DCM was added into the Schlenk flask. The mixture was stirred at 0° C., for 5 minutes. After 5 minutes, 0.0216 mmol (21.6 mg) G2 (see FIG. 6) was added to the mixture at 0° C. The reaction mixture gelled within 1 hour, and after 85 minutes the gelled mixture became solid. At 0° C., 1 mL of EVE and 10 mL DCM were added to the mixture. When the mixture became fluid, 20 mL cool methyl alcohol was added to the flask Immediately, white precipitate formation was observed. The fluid was decanted, and another aliquot of 20 mL cool methyl alcohol was added to the flask. The fluid was again decanted, and the solid residue was moved to a round-bottom flask and dried (silica content: 11%; yield: 84.6%).

### Example 3

### Polypentenamer-Silica Composite with Surface-Modified Silica

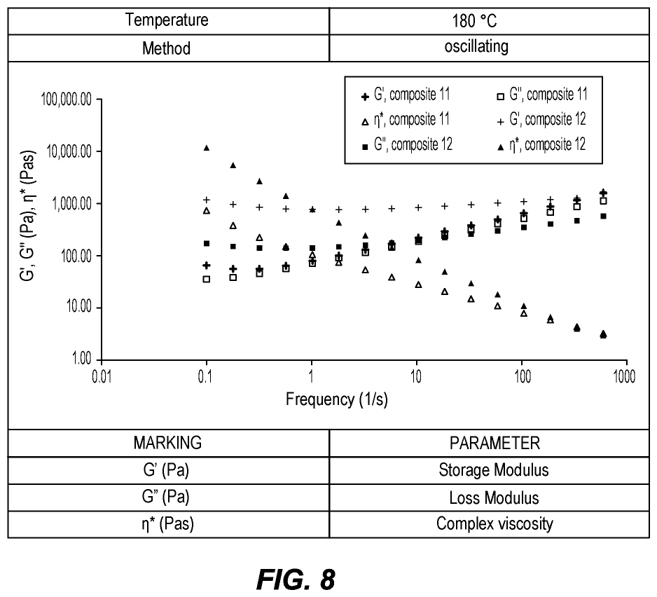

FIG. 7 depicts an exemplary reaction scheme for preparing a composite with the linking compound. The surface-modified silica was dried under vacuum at 40° C., for 4 hours. To a small Schlenk flask, 0.45 g silica and 2.0 mL cyclopentene were added. Then, 1.0 mL DCM was added to the Schlenk flask and stirred at 0° C. for 5 minutes. After 5 minutes, 0.0216 mmol (21.6 mg) G2 was added to the mixture at 0° C. (FIG. 7). The reaction mixture gelled within 2 hours and 40 minutes. After 2 hours and 50 minutes, the gelled mixture became solid. 1 mL of EVE and 10 mL DCM were added to the mixture at 0° C. When the mixture became fluid (after 20 minutes), fluid 20 mL cool methyl alcohol was poured into the flask. Immediately, white precipitate formation was observed. The fluid was decanted and another 20 mL of cool methyl alcohol was added to the flask. The fluid was once more decanted, and the solid residue was poured in a round-bottom flask and dried under vacuum (silica content: 11%; yield: 82.4%).

### Example 4

### Viscosity Testing

It was expected that the viscosity of the composite with the linking compound would be higher than the composite without the linking compound due to the linking between the silica grains and the polymer chains, and the linking between the polymer chains (through the silica grains). To test this, about 0.5 g sample was used on a rotary viscometer, at 180° C., oscillating. G′ (storage modulus), G″ (loss modulus), and q (complex viscosity), were determined and all measured in pascals, as a function of oscillation frequency. The results are provided in FIG. 8.

As reflected in FIG. 8, the composite with surface-modified silica (12) has a greater complex viscosity, because the polymer chains are linked to the silica grains and to each other through the silica grains. In contrast, the composite without surface-modified silica (11) has a lower complex viscosity, because there are no such linkages between the polymer chains and the silica grains.

### Example 5

### Catalytic Decomposition

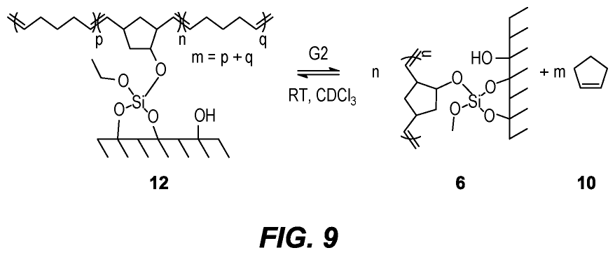

In order to demonstrate the catalytic decomposition of the composite with surface-modified silica, a 2 mg sample of the composite 12 and 1 mg G2 were placed in one NMR tube. A 2 mg sample of the same composite was placed in another NMR tube, but without adding G2. To both tubes, sufficient CDCl₃ was added. The tubes were sealed and the contents were allowed to dissolve. A reaction scheme for decomposing composite 12 with G2 is shown in FIG. 9.

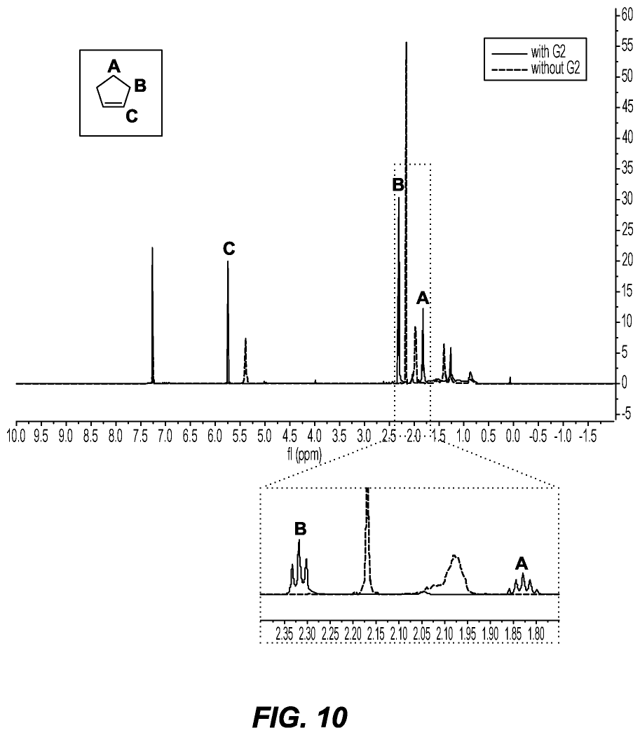

NMR spectra of both samples were recorded. The combined results are reflected in FIG. 10. The spectra demonstrate evidence of cyclopentene in the G2-containing sample, but not in the sample without G2.

It is to be understood that the polypentenamer-silica composite is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

We claim:

1. A polypentenamer-silica composite, comprising a surface-modified silica compound and a polypentenamer chain grafted to the surface-modified silica compound.

2. The polypentenamer-silica composite according to claim 1, wherein the polypentenamer includes trans-polypentenamer.

3. The polypentenamer-silica composite according to claim 1, wherein cyclopentane is incorporated into the polypentenamer chain.

4. The polypentenamer-silica composite according to 1, wherein the composite is

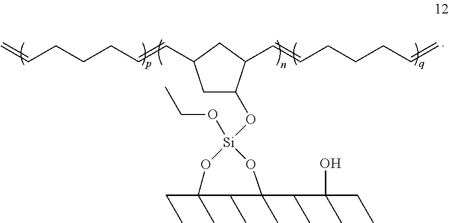

5. A method for preparing the polypentenamer-silica composite of claim 1, comprising:
performing ring opening metathesis polymerization (ROMP) of cyclopentene to provide a trans-polypentenamer; and
co-polymerizing the polypentenamer with a silica-grafted cyclic olefin.

6. The method according to claim 5, wherein the silica-grafted cyclic olefin is:

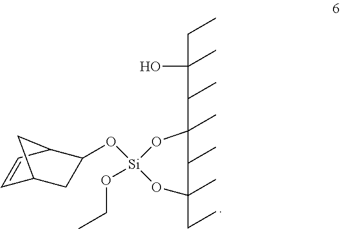 [SMILES: CCO[Si]1(OC2CC3C=CC2C3)OC(C)(CC)C(C)C(C)(C(C)C(C)(O)CC)O1]

7. A recyclable tire, comprising the polypentenamer-silica composite of claim 1.

8. A polypentenamer-silica composite, comprising:
a surface-modified silica compound; and
a polypentenamer chain covalently bound to the surface-modified silica compound, wherein cyclopentane is incorporated into the polypentenamer chain.

9. The polypentenamer-silica composite according to claim 8, wherein the polypentenamer includes trans-polypentenamer.

10. The polypentenamer-silica composite according to 8, wherein the composite is

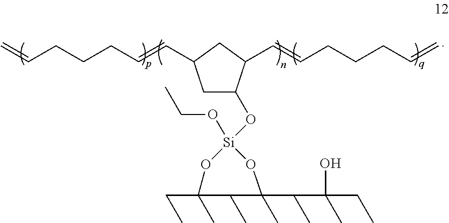

11. A method for preparing the polypentenamer-silica composite of claim 8, comprising:
performing ring opening metathesis polymerization (ROMP) of cyclopentene to provide a polypentenamer;
and co-polymerizing the polypentenamer with a silica-grafted cyclic olefin.

12. The method according to claim 11, wherein the silica-grafted cyclic olefin is:

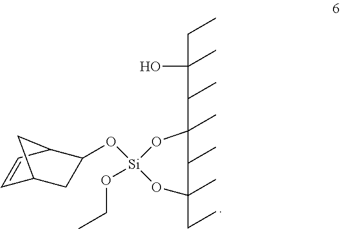 [SMILES: CCO[Si]1(OC2CC3C=CC2C3)OC(C)(CC)C(C)C(C)(C(C)C(C)(O)CC)O1]

13. A recyclable tire, comprising the polypentenamer-silica composite of claim 8.

14. A polypentenamer-silica composite, comprising:

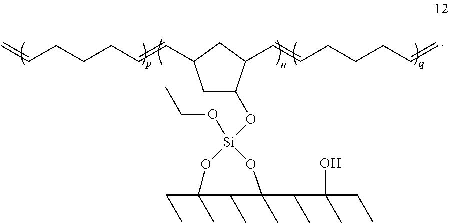

15. A method for preparing the polypentenamer-silica composite of claim 14, comprising:
performing ring opening metathesis polymerization (ROMP) of cyclopentene to provide a polypentenamer; and
co-polymerizing the polypentenamer with a silica-grafted cyclic olefin, wherein the silica-grafted cyclic olefin is

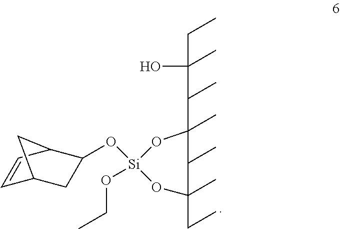 [SMILES: CCO[Si]1(OC2CC3C=CC2C3)OC(C)(CC)C(C)C(C)(C(C)C(C)(O)CC)O1]

16. A recyclable tire, comprising the polypentenamer-silica composite of claim 14.
